(19) United States
(12) Patent Application Publication
(10) Pub. No.: US 2025/0170554 A1
(43) Pub. Date: May 29, 2025

(54) HYDROPHOBIC METAL ORGANIC FRAMEWORK MATERIAL

(71) Applicant: METAL INDUSTRIES RESEARCH & DEVELOPMENT CENTRE, KAOHSIUNG (TW)

(72) Inventors: Chi-Hui CHEN, Kaohsiung City (TW); Lian-Yi TONG, Kaohsiung City (TW); Kuang-Sheng HONG, Taichung City (TW); Pei-Jung LIEN, Kaohsiung City (TW); Lei-Chuan LIN, Kaohsiung City (TW); Chia-Her LIN, Taoyuan City (TW)

(21) Appl. No.: 18/672,011

(22) Filed: May 23, 2024

(30) Foreign Application Priority Data
Nov. 29, 2023 (TW) 112146328

(51) Int. Cl. B01J 20/22; B01D 53/02; B01J 20/30; C07F 5/06

(52) U.S. Cl. CPC B01J 20/226; B01D 53/02; B01J 20/3071; B01J 20/3078; B01J 20/3085; C07F 5/069; B01D 2253/204; B01D 2257/504

(57) ABSTRACT

A hydrophobic metal organic framework (MOF) material includes one or plural metal ion(s), plural multidentates and plural hydrophobic groups. The multidentates are coordinately bonded to the metal ion(s). The multidentates include oxygen atoms and/or nitrogen atoms. The hydrophobic groups form bonds with the oxygen atoms and/or nitrogen atoms on the multidentates, and the hydrophobic groups jointly form 3-dimensional network structure.

### RELATED APPLICATION

This application claims priority to Taiwan Application Serial Number 112146328, filed Nov. 29, 2023, which is herein incorporated by reference.

### BACKGROUND

### Field of Invention

The present invention relates to a metal organic framework material. More particularly, the present invention relates to a metal organic framework material having both gas adsorption capacity and hydrophobicity.

### Description of Related Art

A metal organic framework (MOF) material is a structure composed of organic ligands and metal atoms (ions) or atom cluster. Since the MOF material has extremely high surface area, it can adsorb a large amount of gas; thus, it can be applied in fields of gas adsorption capacity and gas storage. Besides, the MOF material is usually a porous material, and a pore meter and a density of high active zone can be modified compared to conventional porous material. Hence, the MOF material can be applied as catalysts.

Currently, a main carbon capture technique uses liquid amine to adsorb, but such technique still has problems such as high regeneration energy consumption and absorbent degradation. Thus, there's a trend towards development of a highly efficient solid adsorbent to replace the liquid amine in recent years.

The MOF material is a new type of carbon capture solid material, which has characteristics such as easily adsorbed, easily desorbed, high specific surface area and long-lasting; thus, it can help decrease energy consumption cost of carbon capture.

However, problems of moisture instability and insufficient adsorption of carbon dioxide gas still remains in industrial application of the MOF material. In view of the above, it is needed to provide a hydrophobic MOF material to improve the moisture stability and adsorption capacity of carbon dioxide.

### SUMMARY

An aspect of the present invention provides a hydrophobic metal organic framework (MOF) material, which is a MOF material including multidentates and hydrophobic groups. Hence, it can have better carbon dioxide adsorption capacity and moisture stability.

According to the aspect of the present invention, providing a hydrophobic MOF material, which includes one or plural metal ion(s), plural multidentates and plural hydrophobic groups. The multidentates are coordinately bonded to the metal ion(s). The multidentates include oxygen atoms and/or nitrogen atoms. The hydrophobic groups form bonds with the oxygen atoms and/or nitrogen atoms on the multidentates, and the hydrophobic groups are held together to form 3-dimensional network structure.

According to an embodiment of the present invention, the metal ion(s) comprise(s) aluminum ion and/or zinc ion.

According to an embodiment of the present invention, a denticity of the multidentates is in a range between 2 and 12.

According to an embodiment of the present invention, the multidentates including the nitrogen atoms include pyridine groups, nitrile groups, azole groups or combinations thereof.

According to an embodiment of the present invention, the multidentates including the oxygen atoms include carboxyl groups, carbonyl groups, hydroxyl groups or combinations thereof.

According to an embodiment of the present invention, the multidenates include 3,5-pyrazoledicarboxylic acid, 2,5-furandicarboxylic acid, 2,5-thiophenedicarboxylic acid, 2-aminoterephthalic acid, 1,2,4,5-benzenetetracarboxylic acid or combinations thereof.

According to an embodiment of the present invention, the hydrophobic groups include siloxane, and the 3-dimensional network structure includes a plurality of Si—O—Si bonds.

According to an embodiment of the present invention, a mole ratio between the metal ions and the multidentates is 1:6 to 6:1.

According to an embodiment of the present invention, the hydrophobic MOF material has a carbon dioxide (CO₂) adsorption in a range of 2.00 mmol/g to 8.00 mmol/g under an absolute temperature of 298K.

According to an embodiment of the present invention, a contact angle between the hydrophobic MOF material and a surface of liquid water is in a range of 110° to 170°.

According to the aspect of the present invention, providing a hydrophobic MOF material, which includes one or plural MOF(s) and a hydrophobic network structure covalently bonded to the MOF(s). Each of the one or the plurality of metal organic framework(s) includes a metal ion and plural multidentates coordinately bonded to the metal ion. A denticity of the multidentates is in a range between 2 and 12. The hydrophobic network structures include plural hydrophobic groups.

According to an embodiment of the present invention, the metal ion comprises aluminum ion and/or zinc ion.

According to an embodiment of the present invention, the multidentates include nitrogens and/or oxygens.

According to an embodiment of the present invention, the multidentates comprise pyridine groups, nitrile groups, azole groups, carboxyl groups, carbonyl groups, hydroxyl groups or combinations thereof.

According to an embodiment of the present invention, the multidenates comprise 3,5-pyrazoledicarboxylic acid, 2,5-furandicarboxylic acid, 2,5-thiophenedicarboxylic acid, 2-aminoterephthalic acid, 1,2,4,5-benzenetetracarboxylic acid or combinations thereof.

According to an embodiment of the present invention, the hydrophobic network structure includes plural Si-O-Si bonds.

According to an embodiment of the present invention, the hydrophobic groups include siloxane.

According to an embodiment of the present invention, a mole ratio between the one or the plural MOF(s) and the siloxane is 1:10 to 10:1.

According to an embodiment of the present invention, a mole ratio between the metal ion and the multidentates is 1:6 to 6:1.

According to an embodiment of the present invention, the hydrophobic MOF material has a CO₂ adsorption of 2.00 mmol/g to 8.00 mmol/g under an absolute temperature of 298K.

Application of the hydrophobic MOF material uses hydrophobic groups bonded to the MOF material including the multidentates, thereby forming the MOF material with hydrophobicity and great carbon dioxide adsorption capacity.

These and other features, aspects, and advantages of the present invention will become better understood with reference to the following description and appended claims.

It is to be understood that both the foregoing general description and the following detailed description are by examples, and are intended to provide further explanation of the invention as claimed.

### DETAILED DESCRIPTION

As used herein, “around,” “about,” “approximately,” or “substantially” shall generally mean within 20 percent, or within 10 percent, or within 5 percent of a given value or range.

As described above, since the metal organic framework (MOF) material has problems of moisture instability and insufficient adsorption of carbon dioxide gas, in order to improve hydrophobicity and carbon capture effect, the present invention provides the hydrophobic MOF material, which performs hydrophobic modification on the MOF material including multidentates by hydrophobic groups; thus, the MOF material is surrounded by the hydrophobic groups to have better moisture stability and greater carbon dioxide adsorption capacity.

The hydrophobic MOF material includes metal ions, multidentates and hydrophobic groups. The multidentates are coordinately bonded to the metal ions. The hydrophobic groups form bonds with the atoms on the multidentates, and the hydrophobic groups are held together to form a 3-dimensional network structure surrounding the metal ions and the multidentates.

In some embodiments, the hydrophobic MOF material includes compounds represented by formula (1).

[[Mₓ(L)_{y}(L′)_{z}]ₙ][R] (1)

In the formula (1), M represents the metal ion; R represents the hydrophobic groups; L and L′ represent two different multidentates, respectively; x, y, z and n are numbers, which can be adjusted according to coordination type between M and L or L′, and one of y and z can be 0, but cannot both be 0.

The above hydrophobic MOF material is formed from bonding the hydrophobic groups and the MOF material. In some embodiments, the MOF material includes metal ions and the multidentates coordinately bonded to the metal ions. Specifically, the MOF material can be represented by formula (2).

[Mₓ(L)_{y}(L′)_{z}]ₙ (2)

In the formula (2), M represents the metal ion; L and L′ represent two different multidentates, respectively; x, y, z and n are numbers, which can be adjusted according to coordination type between M and L or L′, and one of y and z can be 0, but cannot both be 0.

In some embodiments, a mole ratio between the metal ion and the multidentates is 1:6 to 6:1. When the mole ratio between the metal ion and the multidentates is in the aforementioned range, the process reaction can be completed in shorter reaction time and forms structures of the MOF material.

In some embodiments, the metal ion which M is represented in the above formula (1) can be aluminum ion and/or zinc ion.

In some embodiments, a denticity of the multidentates, which the L represented in the above formula (1), is in a range between 2 and 12. It is understood that the denticity refers to atom numbers of a single ligand that binds to the central atom in a coordination complex. In other words, the ligand with the denticity of 2 is referred to as bidentate ligand, while the ligand with the denticity of 6 is referred to as hexadentate ligand.

In some embodiments, compounds of the above multidentates include multidentates including oxygens and/or multidentates including nitrogens. In the above embodiments, the multidentates including oxygens can include carboxyl groups, carbonyl groups, hydroxyl groups or combinations thereof, and the multidentates including nitrogens can include pyridine groups, nitrile groups, azole groups or combinations thereof.

In some examples, the compounds of the above multidentates include 3,5-pyrazoledicarboxylic acid, 2,5-furandicarboxylic acid, 2,5-thiophenedicarboxylic acid, 2-aminoterephthalic acid, 1,2,4,5-benzenetetracarboxylic acid or combinations thereof.

A method of forming the hydrophobic MOF material includes synthesizing the MOF material first. The MOF material is formed by mixing a metal compound and the compound of the multidentates in a solvent to form a solution. Then, the solution is heated to about 80° C. to about 150° C., thereby forming the MOF material. In some embodiments, a reaction time of the metal compound and the compound of the multidentates is about 1 hour and about 72 hours, and is preferably about 1 hour and about 3 hours. The aforementioned reaction time can make sure the reaction of the metal compound and the compound of the multidentates completely and form the desired structure of the MOF material.

In some embodiments, after heating the solution, rinsing obtained solid products can be performed optionally, and the solid products can be dried and activated to obtain the MOF material. In the aforementioned embodiments, the rinsing operation can be performed with an organic solvent, such as methanol, ethanol and dimethyl formamide, and/or water. In the aforementioned embodiments, condition of the drying and activation operation can be heating at a temperature of about 50° C. to about 150° C. for about 0.5 hour to about 24 hours.

The metal compounds can be compounds including aluminum or zinc, there's no specific limitation. In some embodiments, the metal compound can include but is not limited to aluminum nitrate, aluminum sulfate, aluminum chloride, aluminum phosphate, sodium aluminate, aluminum acetate, aluminum formate, aluminum propionate, aluminum butoxide, aluminum hydroxide, zinc nitrate, zinc sulfate, zinc chloride, zinc phosphate, sodium zincate, zinc acetate, zinc formate, zinc propionate, zinc butyrate, zinc hydroxide and combinations thereof.

In some embodiments, the above solvent can be the organic solvent, such as N,N-dimethylformamide (DMF), water or combinations thereof. In the aforementioned embodiments, when the solvent is water, the solvent can optionally include an acid-alkali adjusting agent, thereby increasing compatibility of the metal compound and the compounds of the multidentates. In some examples, the acid-alkali adjusting agent includes sodium hydroxide, potassium hydroxide, formic acid, acetic acid, or combinations thereof.

In some embodiments, X-ray diffraction spectrum of the MOF material has 20 value of a first maximum peak of 3.0 degree to 10.0 degree, and 20 value of a second maximum peak of 13.0 degree to 22.0 degree.

Subsequently, the method of forming the hydrophobic MOF material further includes performing a hydrophobic modification to the MOF material, which is performed by mixing the MOF material and a compound including the hydrophobic groups (silane compounds, for example) in another solvent, thereby bonding the MOF material to the plural hydrophobic groups, resulting in the hydrophobic MOF material, as the above formula (1). In the case of the silane compounds, silicon atoms of the hydrophobic MOF material can form bonds with the oxygen atoms or the nitrogen atoms of the multidentates. In some embodiments, the solvent can be toluene, n-hexane or mixture thereof. The method of the aforementioned mixing can include but not limited to stirring, immersing and/or coating.

Since the obtained MOF material has plenty of hydrophilic groups (hydroxyl groups or carbonyl groups, for example), it tends to adsorb water. Hence, in some embodiments, the silane compounds can be used to make silanization reaction on the MOF material, thereby bonding plural siloxane groups on the MOF material. The silane compound can form Si—O—Si bonds with each other to form the 3-dimensional network structure surrounding the MOF material. Accordingly, the MOF material can be formed as the hydrophobic MOF material.

In some embodiments, the silane compounds can be trichlorosilane, tribromosilane, triiodosilane, trichlorofluorosilane or other suitable silane compounds. The silane compounds preferably include alkyl groups with carbon number of 1 to 18; thus, the obtained hydrophobic MOF material can remain great carbon dioxide adsorption capacity. The carbon number of the aforementioned silane compounds can be adjusted according to characteristics of the reactants (i.e. the MOF material). In some embodiments, a mole ratio between the MOF material and the silane compounds is 1:10 to 10:1 approximately, and preferably 1:1 to 10:1 approximately. If too much silane compounds were added, the hydrophobic MOF material would bond to excess siloxane groups, and it might lead to poor follow-on applicability. On the contrary, if too less silane compounds were added, hydrophobicity of the hydrophobic MOF material could not be affectively improved.

In some embodiments, a reaction time of the MOF material and the compounds including hydrophobic groups is about 0.25 hour to about 3 hours, and preferably 0.5 hour. The reaction time should be adjusted according to characteristics of the reactants, which should assure the reactants can be reacted completely.

Since the hydrophobic MOF material has greater pore volume and specific surface area, it is advantageous to be applied in adsorption and desorption of gas, and for example, it can have greater carbon dioxide adsorption capacity. In some embodiments, the hydrophobic MOF material has a carbon dioxide adsorption in a range of 2.00 mmol/g to 8.00 mmol/g approximately under an absolute temperature of 298 K.

In some embodiments, a contact angle between the hydrophobic MOF material and a surface of liquid water is in a range of 110° to 170° approximately. Therefore, the hydrophobic MOF material of the present invention has excellent moisture stability, and it can avoid hydration reaction occurring during related operations such as gas adsorption and desorption, which may lead to degradation of performance.

The following Embodiments are provided to better elucidate the practice of the present invention and should not be interpreted in anyway as to limit the scope of same. Those skilled in the art will recognize that various modifications may be made while not departing from the spirit and scope of the invention.

### Embodiment 1

A solution was formed by dissolving aluminum chloride hexahydrate (AlCl₃·6H₂O), 3,5-pyrazoledicarboxylic acid and sodium hydroxide in water in embodiment 1, in which a mole ratio between aluminum chloride hexahydrate and 3,5-pyrazoledicarboxylic was in a range of 1:3 to 2:1. Subsequently, the solution was heated to a range between 100° C. and 150° C., and reaction time was in a range between 2 hours and 12 hours.

After completing the reaction, precipitated white solids were collected. The solids were rinsed by water and methanol for 3 times and were heated under vacuum at a temperature between 90° C. and 120° C. for 30 minutes to 60 minutes, thereby obtaining white solids of the MOF material of embodiment 1.

Then, the MOF material and trichlorosilane were dissolved in toluene, in which a mole ratio between the MOF material and the trichlorosilane was between 1:10 and 10:1. The reaction was occurred at room temperature, and the reaction time was between 0.5 hour and 3 hours. As such, the hydrophobic MOF material of embodiment 1 was obtained.

### Embodiment 2

A solution was formed by dissolving aluminum chloride hexahydrate (lCl₃·6H₂O), 2,5-furandicarboxylic acid and sodium hydroxide in water in embodiment 2, in which a mole ratio between aluminum chloride hexahydrate and 2,5-furandicarboxylic acid was in a range of 1:3 to 2:1. Subsequently, the solution was heated to a range between 100° C. and 150° C., and reaction time was in a range between 1 hour and 12 hours.

After completing the reaction, precipitated white solids were collected. The solids were rinsed by water for 3 times and were heated under vacuum at a temperature between 90° C. and 120° C. for 30 minutes to 60 minutes, thereby obtaining white solids of the MOF material of embodiment 2.

Then, a hydrophobic modification was performed on the MOF material using the same process as embodiment 1, thereby obtaining the hydrophobic MOF material of embodiment 2.

### Embodiment 3

A solution was formed by dissolving aluminum chloride hexahydrate (AlCl₃·6H₂O), sodium aluminate (NaAIO2), 2,5-furandicarboxylic acid, 2,5-thiophenedicarboxylic acid and sodium hydroxide in water in embodiment 3, in which a mole ratio between a combination of aluminum chloride hexahydrate and sodium aluminate and a combination of 2,5-furandicarboxylic acid and 2,5-thiophenedicarboxylic acid was in a range of 1:3 to 2:1. Subsequently, the solution was heated to a range between 100° C. and 150° C., and reaction time was in a range between 1 hour and 12 hours.

After completing the reaction, precipitated white solids were collected. The solids were rinsed by water for 3 times and were heated under vacuum at a temperature between 90° C. and 120° C. for 30 minutes to 60 minutes, thereby obtaining white solids of the MOF material of embodiment 3.

Then, a hydrophobic modification was performed on the MOF material using the same process as embodiment 1, thereby obtaining the hydrophobic MOF material of embodiment 3.

### Embodiment 4

A solution was formed by dissolving sodium aluminate (NaAlO₂),

1,2,4,5-benzenetetracarboxylic acid and acetic acid in water in embodiment 4, in which a mole ratio between sodium aluminate (NaAlO₂) and 1,2,4,5-benzenetetracarboxylic acid was in a range of 1:3 to 4:1. Subsequently, the solution was heated to a range between 100° C. and 150° C., and reaction time was in a range between 1 hour and 24 hours.

After completing the reaction, precipitated white solids were collected. The solids were rinsed by water for 3 times and were heated under vacuum at a temperature between 90° C. and 120° C. for 30 minutes to 60 minutes, thereby obtaining white solids of the MOF material of embodiment 4.

Then, the MOF material and trichlorosilane were dissolved in hexane, in which a mole ratio between the MOF material and the trichlorosilane was between 1:10 and 10:1. The reaction was occurred at room temperature, and the reaction time was between 0.5 hour and 3 hours. As such, the hydrophobic MOF material of embodiment 4 was obtained.

### Embodiment 5

A solution was formed by dissolving aluminum chloride hexahydrate (AlCl₃·6H₂O) and 2-aminoterephthalic acid in N,N-dimethyl formamide in embodiment 5, in which a mole ratio between aluminum chloride hexahydrate and 2-aminoterephthalic acid was in a range of 1:3 to 2:1. Subsequently, the solution was heated to a range between 100° C. and 150° C., and reaction time was in a range between 1 hour and 12 hours.

After completing the reaction, precipitated white solids were collected. The solids were rinsed by N,N-dimethyl formamide and acetone for 3 times and were heated under vacuum at a temperature between 70° C. and 90° C. for 30 minutes to 60 minutes, thereby obtaining white solids of the MOF material of embodiment 5.

Then, a hydrophobic modification was performed on the MOF material using the same process as embodiment 1, thereby obtaining the hydrophobic MOF material of embodiment 5.

### Analysis of the MOF Material

D8 Phaser of Bruker was used to analyze the MOF material of embodiment 1 to embodiment 5 by X-ray diffraction. The X-ray diffraction spectra showed that 2θ value of a first maximum peak of 3.0 degree to 10.0 degree, and 2θ value of a second maximum peak of 13.0 degree to 22.0 degree. The results were data transformed and compared to theoretical crystallographic data of Cambridge Crystallographic Data Center (CCDC), and it was confirmed that the crystal structure matched the theoretical data.

### Analysis of the Hydrophobic MOF Material

### Examination of Hydrophobicity

Deionized water was dropped on a surface of the hydrophobic MOF materials of embodiment 1 to embodiment 5, and then a contact angle meter was used to examine a water contact angle of the hydrophobic MOF materials. The examined water contact angle was between 110° to 170°, as shown in following table 1.

### Examination of Carbon Dioxide Adsorption Capacity

The hydrophobic MOF materials of embodiment 1 to embodiment 5 were put in measuring flasks, respectively, and the measuring flasks were placed in a cooling environment. A gravimetric method was used to measure carbon dioxide adsorption capacity. Measuring condition was room pressure and a temperature of 25° C. (which was absolute temperature of 298K). The obtained carbon dioxide adsorption capacity was 2.00 mmol/g to 8.00 mmol/g, as shown in the following table 1.

TABLE 1

| | | | contact | carbon dioxide |
|---|---|---|---|---|
| | | | angle | adsorption |
| | metal compounds | compounds of multidentates | (degree) | (mmole/g) |
| Embodiment 1 | aluminum chloride | 3,5-pyrazoledicarboxylic acid | 137 | 3.69 |
| Embodiment 2 | aluminum chloride | 2,5-furandicarboxylic acid | 124 | 3.2 |
| Embodiment 3 | aluminum chloride + | 2,5-furandicarboxylic acid + | 130 | 2.67 |
| | sodium aluminate | 2,5-thiophenedicarboxylic acid | | |
| Embodiment 4 | sodium aluminate | 1,2,4,5-benzenetetracarboxylic | 113 | 3.08 |
| | | acid | | |
| Embodiment 5 | aluminum chloride | 2-aminoterephthalic acid | 124 | 2.2 |

According to above embodiments, the hydrophobic MOF material provided by the present invention is obtained by using hydrophobic groups bonded to the MOF material including the multidentates, thereby obtaining the hydrophobic MOF material having both hydrophobicity and carbon dioxide adsorption capacity.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A hydrophobic metal organic framework material, comprising:
one or a plurality of metal ion(s);
a plurality of multidentates, coordinately bonded to the one or the plurality of metal ion(s), wherein the multidentates comprise oxygen atoms and/or nitrogen atoms; and
a plurality of hydrophobic groups, wherein the hydrophobic groups form bonds with the oxygen atoms and/or nitrogen atoms on the multidentates, and the hydrophobic groups are held together to form a 3-dimensional network structure.

2. The hydrophobic metal organic framework material of claim 1, wherein the one or the plurality of metal ion(s) comprise(s) aluminum ion and/or zinc ion.

3. The hydrophobic metal organic framework material of claim 1, wherein a denticity of the multidentates is in a range between 2 and 12.

4. The hydrophobic metal organic framework material of claim 1, wherein the multidentates comprising the nitrogen atoms comprise pyridine groups, nitrile groups, azole groups or combinations thereof.

5. The hydrophobic metal organic framework material of claim 1, wherein the multidentates comprising the oxygen atoms comprise carboxyl groups, carbonyl groups, hydroxyl groups or combinations thereof.

6. The hydrophobic metal organic framework material of claim 1, wherein the multidenates comprise 3,5-pyrazoledicarboxylic acid, 2,5-furandicarboxylic acid, 2,5-thiophenedicarboxylic acid, 2-aminoterephthalic acid, 1,2,4,5-benzenetetracarboxylic acid or combinations thereof.

7. The hydrophobic metal organic framework material of claim 1, wherein the hydrophobic groups comprise siloxane, and the 3-dimensional network structure comprises a plurality of Si—O—Si bonds.

8. The hydrophobic metal organic framework material of claim 1, wherein a mole ratio between the one or the plurality of metal ions and the multidentates is 1:6 to 6:1.

9. The hydrophobic metal organic framework material of claim 1, wherein the hydrophobic metal organic framework material has a carbon dioxide (CO₂) adsorption in a range of 2.00 mmol/g to 8.00 mmol/g under an absolute temperature of 298K.

10. The hydrophobic metal organic framework material of claim 1, wherein a contact angle between the hydrophobic metal organic framework material and a surface of liquid water is in a range of 110° to 170°.

11. A hydrophobic metal organic framework material, comprising:
one or a plurality of metal organic framework(s), wherein each of the one or the plurality of metal organic framework(s) comprises:
a metal ion; and
a plurality of multidentates coordinately bonded to the metal ion, wherein a denticity of the multidentates is in a range between 2 and 12; and
a hydrophobic network structures covalently bonded to the one or the plurality of metal organic framework(s), wherein the hydrophobic network structures comprise a plurality of hydrophobic groups.

12. The hydrophobic metal organic framework material of claim 11, wherein the metal ion comprises aluminum ion and/or zinc ion.

13. The hydrophobic metal organic framework material of claim 11, wherein the multidentates comprise nitrogens and/or oxygens.

14. The hydrophobic metal organic framework material of claim 11, wherein the multidentates comprise pyridine groups, nitrile groups, azole groups, carboxyl groups, carbonyl groups, hydroxyl groups or combinations thereof.

15. The hydrophobic metal organic framework material of claim 11, wherein the multidenates comprise 3,5-pyrazoledicarboxylic acid, 2,5-furandicarboxylic acid, 2,5-thiophenedicarboxylic acid, 2-aminoterephthalic acid, 1,2,4,5-benzenetetracarboxylic acid or combinations thereof.

16. The hydrophobic metal organic framework material of claim 11, wherein the hydrophobic network structure comprises a plurality of Si—O—Si bonds.

17. The hydrophobic metal organic framework material of claim 11, wherein the hydrophobic groups comprise siloxane.

18. The hydrophobic metal organic framework material of claim 17, wherein a mole ratio between the one or the plurality of metal organic framework(s) and the siloxane is 1:10 to 10:1.

19. The hydrophobic metal organic framework material of claim 11, wherein a mole ratio between the metal ion and the multidentates is 1:6 to 6:1.

20. The hydrophobic metal organic framework material of claim 11, wherein the hydrophobic metal organic framework material has a CO₂ adsorption of 2.00 mmol/g to 8.00 mmol/g under an absolute temperature of 298K.
